(19) United States
(12) Patent Application Publication
(10) Pub. No.: US 2025/0247594 A1
(43) Pub. Date: Jul. 31, 2025

(54) Systems and Methods for Camera Protection in Hazardous Environments

(71) Applicant: Veolia Nuclear Solutions, Inc., Lafayette, CO (US)

(72) Inventor: Keith Witwer, Kennewick, WA (US)

(21) Appl. No.: 19/077,953

(22) Filed: Mar. 12, 2025

Related U.S. Application Data
(62) Division of application No. PCT/IB2023/061298, filed on Nov. 9, 2023.
(60) Provisional application No. 63/386,780, filed on Dec. 9, 2022.

(51) Int. Cl. H04N 23/52; G01J 5/00; G01J 5/08; G01J 5/10; G02B 5/08; H04N 23/20; H04N 23/50; H04N 23/51

(52) U.S. Cl. CPC H04N 23/52; G01J 5/0814; G01J 5/10; G02B 5/0808; H04N 23/20; H04N 23/51; H04N 23/555; G01J 2005/0077

(57) ABSTRACT

A system may include a camera, wherein the camera comprises at least a camera lens and a camera body, and wherein the camera lens and the camera body are oriented at an angle to a viewport and a source of radiation. A system may include a first surface mirror or second surface mirror operably placed in front of the camera lens, and wherein a surface of the first surface mirror or second surface mirror is coated with a reflective material. A system may include shielding, wherein the shielding protects the camera from gamma radiation.

### TECHNICAL FIELD

This disclosure relates generally to systems and methods for protecting a camera from a hazardous environment. More specifically, the disclosure relates to use and protection of cameras used for monitoring vitrification processes.

### BACKGROUND

Vitrification treatment systems may employ an infrared (IR) Camera to monitor interior processes of the melter hood and the melt surface. Generally, an IR camera is placed near, next, or adjacent to the exterior of the melter hood with the imaging lens pointed inward, toward the melt surface. The camera lens is typically isolated from the plenum atmosphere by means of a germanium or zinc selenide viewport that is transparent to the long wave IR emissions measured by the camera.

Higher activity waste emits alpha, beta and gamma radiation in varying amounts, depending on the type of waste being treated with a vitrification process. Of these three, gamma radiation has the unique ability to pass through a variety of materials with little attenuation from those materials. As a result, the camera IR sensor, associated electronics, and various non-metal materials used in its construction can be severely degraded and eventually rendered non-functional after sufficient exposure time to the gamma radiation, thus requiring regular replacement. For this very reason, and as example, the need for protection of electronic imaging systems and other sensors from cosmic radiation is amply documented and is a specific priority in the design and construction of space-based systems.

Currently, mitigating the challenge in a hazardous environment involves the placement of a high-density material between the radiation source and the item to be protected, commonly referred to as shielding. However, shielding also effectively blocks the IR emissions needed to resolve an image onto the IR camera's thin-film transistor (TFT) circuitry.

What is needed in the art is a system and method that would allow a coated prismatic system to reflect long wave IR signals with minimal attenuation to an IR camera lens on a positioned camera but would not reflect or absorb the gamma radiation. This would allow the camera to be positioned safely away from the gamma radiation while still able to measure IR transmissions for imaging.

### GENERAL DESCRIPTION

A right-angle first surface mirror or second surface mirror, coated with a thin reflective gold layer, is incorporated in front of the camara lens that is normally pointed at the waste surface. This front-mounted first surface mirror or second surface mirror would enable the camera body and lens to be oriented at a right angle to the viewport on the melt hood and thus the melt surface and source of radiation. The enabling function of the thin gold coating on the first surface mirror or second surface mirror is to reflect the long wave infrared signals with minimal attenuation but is not expected to reflect or absorb the gamma radiation. Instead, the gamma radiation would pass through the low-density first surface mirror or second surface mirrors unimpeded. The camera components exposed to the gamma radiation would be shielded by lead or other high-density material, thereby reducing their resultant exposure to manageable radiation levels.

### DESCRIPTION OF DRAWINGS

A more complete understanding of the systems, methods, processes, and apparatuses disclosed herein may be derived by referring to the detailed description when considered in connection with the accompanying illustrative figures. In the figures, like-reference numbers refer to like-elements or acts throughout the figures.

FIG. 1A is a section side view of an embodiment of a camera protection system.

FIG. 1B is a front view of the embodiment of FIG. 1A.

FIG. 2 is a perpendicular view of an embodiment of the embodiment of FIG. 1A.

FIG. 3 depicts a protective housing for a camera.

FIG. 4 depicts an isometric view of an exemplary melter with a camera system coupled to it.

FIG. 5 depicts a top view of the system of FIG. 4.

FIG. 6 depicts a front view of the system of FIG. 4.

FIG. 7 depicts a section view of the system of FIG. 4.

FIG. 8 depicts an embodiment of an electronic computing device.

FIG. 9 depicts an embodiment of the devices that can be included as part of the electronic computing device of FIG. 8.

Elements and acts in the figures are illustrated for simplicity and have not necessarily been rendered according to any particular sequence or embodiment.

### DETAILED DESCRIPTION OF EMBODIMENTS

Before any embodiments of the present disclosure are explained in detail, it is to be understood that the systems and methods disclosed herein are not limited in its application to the details of construction and the arrangement of components set forth in the following description or illustrated in the accompanying drawings. The systems and methods disclosed herein are capable of other embodiments and of being practiced or of being carried out in various ways. It should be noted that there are many different and alternative configurations, devices, and technologies to which the disclosed embodiments may be applied. The full scope of the embodiments is not limited to the examples that are described below.

In the following examples of the illustrated embodiments, references are made to the accompanying drawings which form a part hereof, and in which is shown by way of illustration various embodiments in which the systems, methods, processes, and/or apparatuses disclosed herein may be practiced. It is to be understood that other embodiments may be utilized, and that structural and functional changes may be made without departing from the scope of the present disclosure.

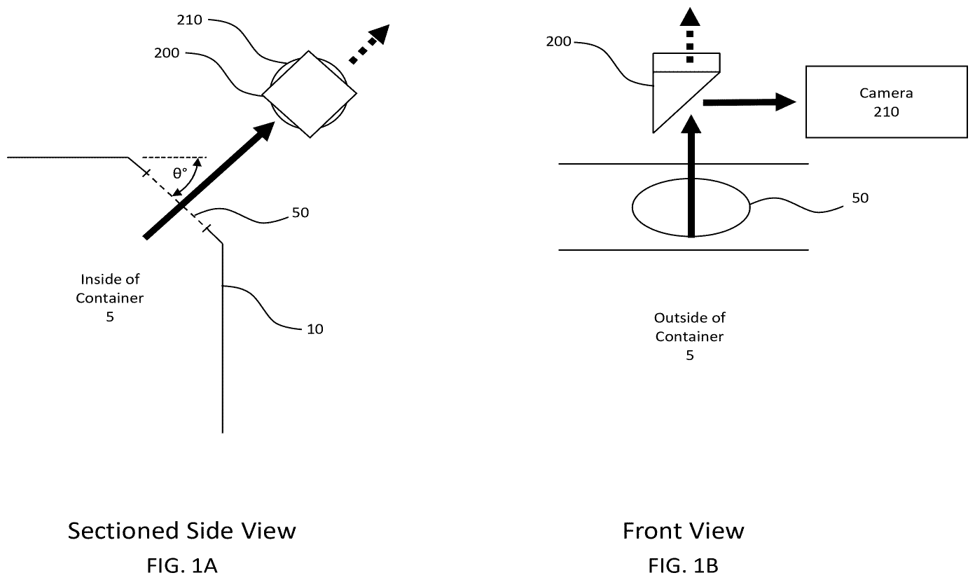

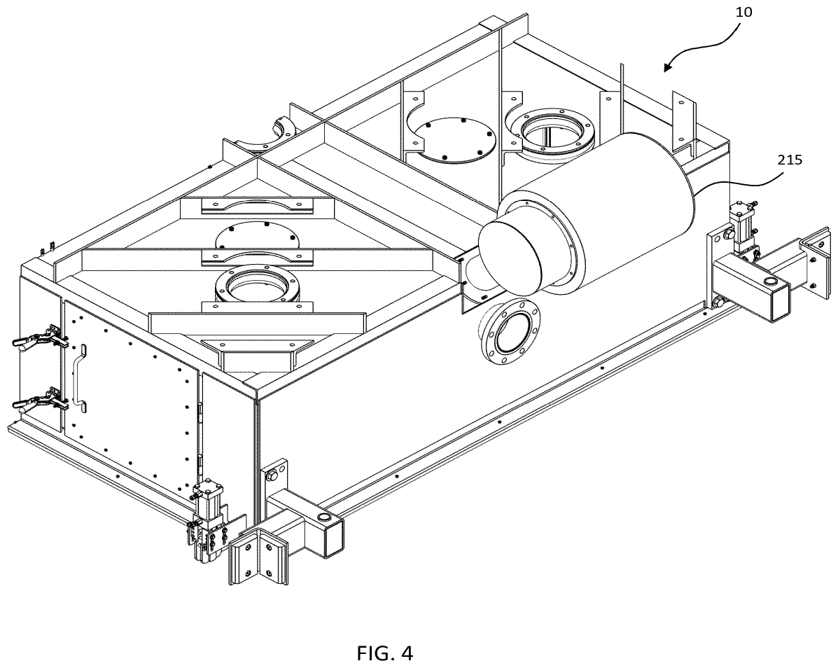

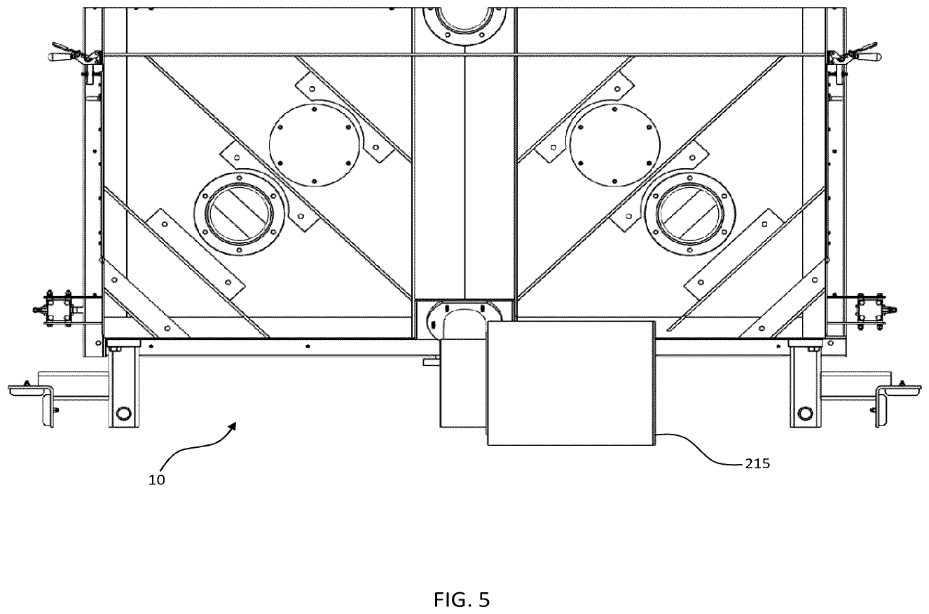

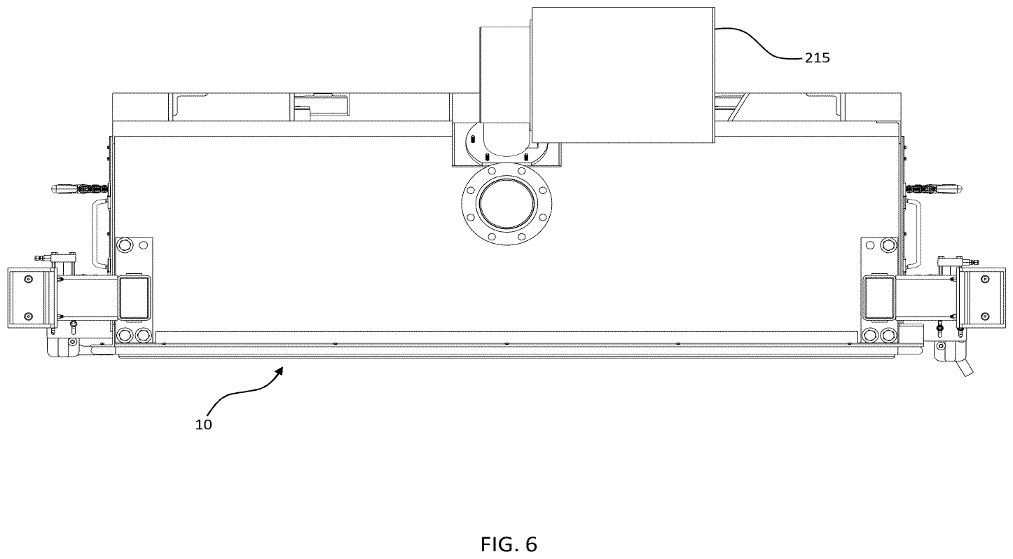

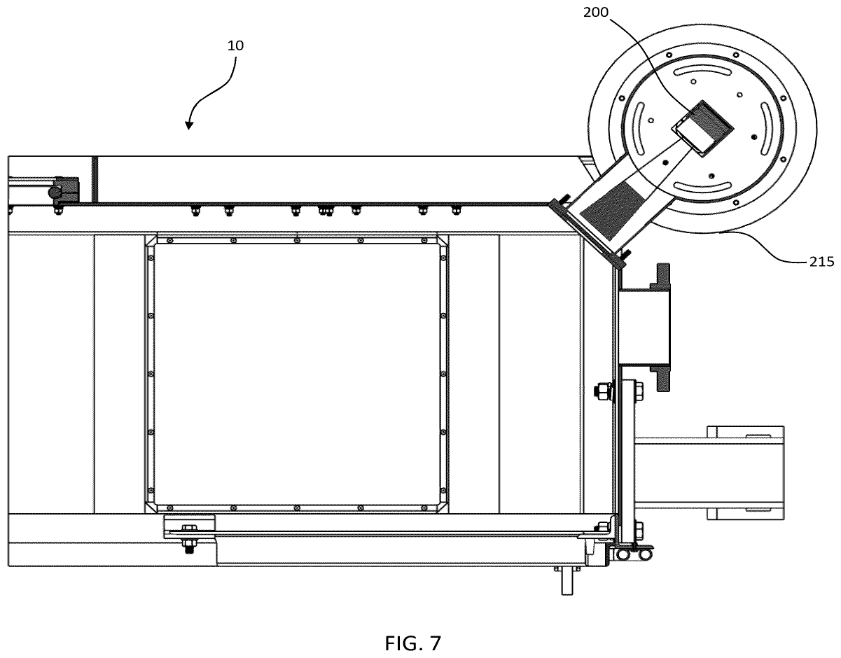

Various views of systems and method embodiments for camera protection in hazardous environments are depicted in FIGS. 1 through 7. In some embodiments, such as those depicted in FIGS. 4-7, the systems and methods disclosed herein may be applied to vitrification processes for hazardous or radioactive wastes.

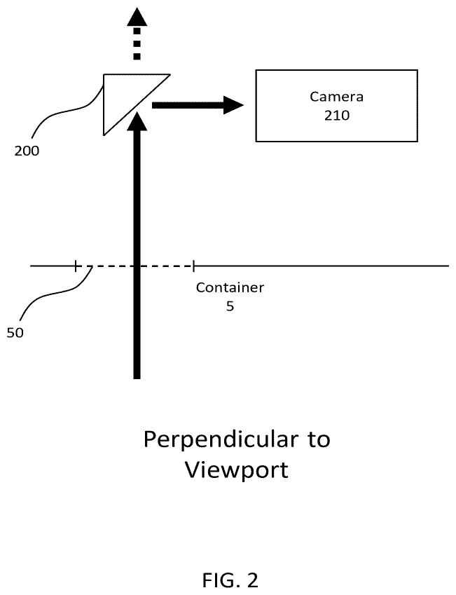

FIGS. 1A, 1B, and 2 depict an embodiment of a camera protection system. In the depicted embodiment, the viewport 50 is angled at θ° with respect to the top surface of the exemplary container 5 containing the subject of interest. The angle θ may be between 0° and 60°. In some embodiments, the camera system may be utilized without a container 5. The container 5 is depicted to provide perspective to the drawings but is not necessary for system functionality.

Normally, a camera 210 lens is pointed directly at the subject of interest, which may be the waste surface in waste vitrification embodiments. In some embodiments, a right-angle first surface mirror or second surface mirror 200 may be placed in front of a camera 210 lens which enables the camera body 210 and lens to be oriented at an angle relative to the viewport 50 on the container 5, or, in vitrification embodiments, the melt surface and source of radiation. In some embodiments, implementation of a right-angle first surface mirror or second surface mirror 200 may result in lower transmission loss and less attenuation of an IR signal over time in a high gamma radiation field.

In some embodiments, one or more surfaces of the right-angle first surface mirror or second surface mirror 200 may be coated with a reflective layer. In some embodiments wherein a right-angle first surface mirror 200 is implemented, the right-angle first surface mirror 200 may be coated externally. In some embodiments wherein a second surface mirror 200 is implemented, the second surface mirror 200 may be coated internally. In some embodiments, the reflective layer is a gold film. In some embodiments, the reflective layer may be comprised of aluminum or silver.

The enabling function of the reflective layer on the first surface mirror or second surface mirror 200 is that it reflects 96%-99% of long wave IR signals (depicted as thick solid arrow) with minimal attenuation (1%-4%) but does not reflect or absorb the gamma radiation (depicted as thick dashed arrow) due to the extremely short wavelength (high frequency). Instead, the gamma radiation may pass through the low-density first surface mirror or second surface mirror 200 material and film layer unimpeded. The camera 210 and any components that may be exposed to the gamma radiation may be shielded by lead or other high-density material(s), thereby reducing their resultant exposure to manageable radiation levels.

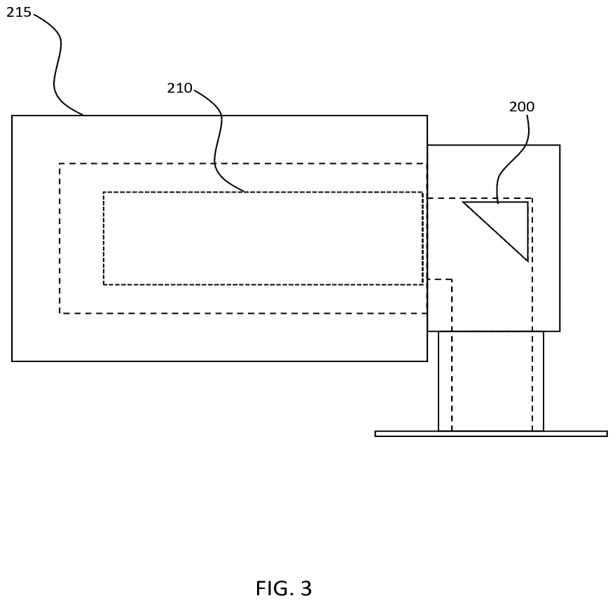

FIG. 3 depicts an embodiment of a camera 210 and protective housing 215. In some embodiments, the housing 210 comprises an outer layer of protective lead shielding. In some embodiments, the shielding may be 60 mm to 65 mm thick. In some embodiments, shielding thickness may vary depending on the working environment. In some embodiments, the shielding may reduce the total accumulated dose to 100 Gy (1×104 rad). Many commercial off-the-shelf (COTS) imaging systems (e.g., Mirion radiation tolerant cameras) advertise maximum total allowable dose of 100 Gy (1×104 rad). In some embodiments, the design life of the system may be around 22,000 hours. In some embodiments, the expected usage may result in an average allowable dose rate of 0.0046 Gy/hr (0.46 rad/hr). FIGS. 4 through 7 depict various views of the systems and methods disclosed herein being used with vitrification processes for hazardous or radioactive wastes.

The embodiments described above and illustrated in the figures are presented by way of example only and are not intended as a limitation upon the concepts and principles of the present disclosure. As such, it will be appreciated by one having ordinary skill in the art that various changes in the elements and their configuration and arrangement are possible without departing from the spirit and scope of the present disclosure as set forth in the appended claims.

### Electronic Computing Device

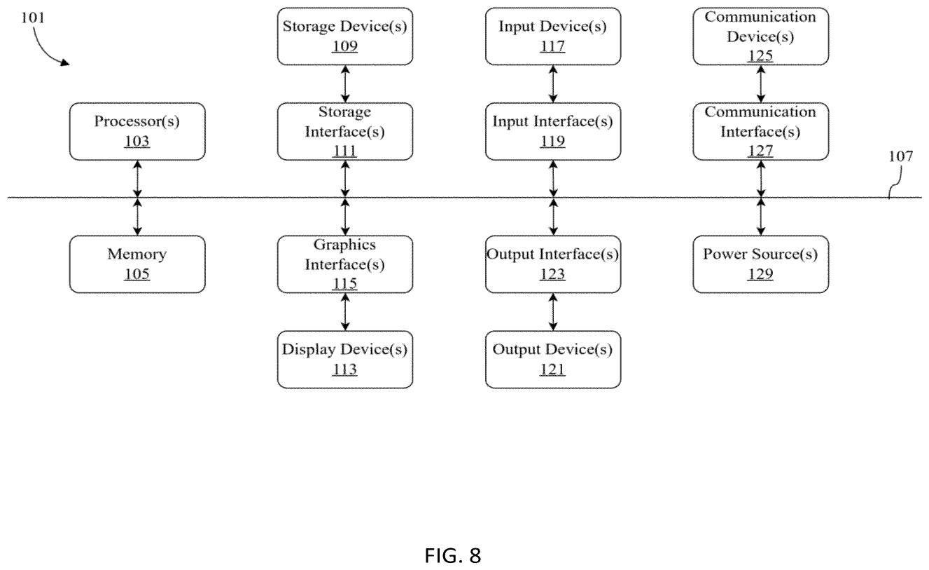

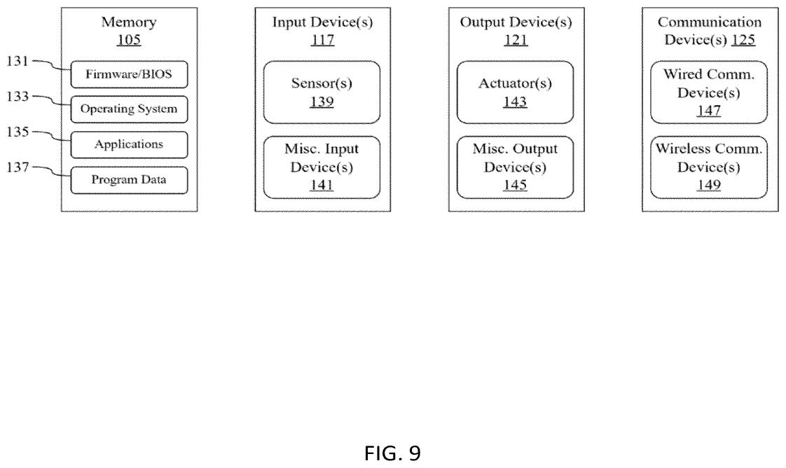

FIG. 8 shows one embodiment of an electronic computing device 101 (alternatively referred to as an electronic controller, programmable logic controller, electronic control system, or electronic computing system) that can be part of the system. The electronic computing device 101 can be used to control the system in any of the ways described above. FIG. 9 shows embodiments of the devices that can be included as part of the electronic computing device 101.

The electronic computing device 101 includes one or more processors 103 (alternatively referred to as a digital processing unit or microprocessor) and memory 105 communicatively linked to each other by way of a system bus 107. In some embodiments, the electronic computing device 101 can also include one or more other interfaces and/or devices communicatively linked to the system bus 107.

For example, one or more storage devices 109 can be communicatively linked to the system bus 107 by way of one or more storage interfaces 111. One or more display devices 113 can be communicatively linked to the system bus 107 by way of one or more graphics interfaces 115. One or more input devices 117 can be communicatively linked to the system bus 107 by way of one or more input interfaces 119. One or more output devices 121 can be communicatively linked to the system bus 107 by way of one or more output interfaces 123. One or more communication devices 125 can be communicatively linked to the system bus 107 by way of one or more communication interfaces 127.

It should be appreciated that the electronic computing device 101 can have a variety of configurations. For example, in some embodiments, the various components of the electronic computing device 101 can be positioned near each other in a single housing, a few housings, a single board, a few boards communicatively linked together, or the like. In other embodiments, the various components of the electronic computing device 101 can be located remotely. For example, the one or more input devices 117 and/or the one or more output devices 121 can be located remotely or at a distance from the one or more processors 103 and/or the memory 105.

### Processor

Each of the one or more processors 103 is an electric circuit such as an integrated circuit that executes program instructions. The processor 103 can perform operations such as arithmetic operations, logic operations, controlling operations, and input/output (I/O) operations specified by the program instructions. In some embodiments, the processor 103 includes a control unit (CU), an arithmetic logic unit (ALU), and/or a memory unit (alternatively referred to as cache memory).

The control unit can direct the operation of the processor 103 and/or instruct the memory 105, arithmetic logic unit, and output devices 121 how to respond to instructions in the program. It can also direct the flow of data or information between the processor 103 and other components of the electronic computing device 101. It can also control the operation of other components by providing timing and control signals.

The arithmetic logic unit is an electric circuit in the processor 103 that performs integer arithmetic and bitwise logic operations. The arithmetic logic unit receives input in the form of data or information to be operated on and code describing the operation to be performed. The arithmetic logic unit provides the result of the performed operation as output. In some configurations, the arithmetic logic unit can also include status inputs and/or outputs that convey information about a previous operation or the current operation between the arithmetic logic unit and external status registers.

It should be appreciated that the processor 103 can have any suitable configuration. For example, the processor 103 can range from a simple processor specially built or configured to execute one or more programs for a specific application or device to a complex central processing unit configured to be used in a wide variety of ways and an equally wide variety of applications. Examples of processors 103 include a general-purpose processor, a digital signal processor (DSP), an application specific integrated circuit (ASIC), a central processing unit (CPU), a field programmable gate array (FPGA) or other programmable logic device, and/or discrete gate or transistor logic. The processor 103 can also be implemented as any individual or combination of these devices.

### Memory

The memory 105 (alternatively referred to as primary memory, main memory, or a computer-readable medium) is a semiconductor device or system used to store information for immediate use by the processor 103. The memory 105 is generally directly accessible to the processor 103. The processor 103 can read and execute program instructions stored in the memory 105 as well as store data and/or other information in the memory 105 that is actively being operated on. The memory 105 is generally more expensive and operates at higher speeds compared to the storage device 109. The memory 105 can be volatile such as random-access memory (RAM) or non-volatile such as read-only memory (ROM).

### System Bus

The system bus 107 broadly refers to the communication system through which information is transferred between the processor 103, the memory 105, and/or other components such as peripherals that can be considered part of the electronic computing device 101. The system bus 107 can include a physical system of connectors, conductive pathways, optical pathways, wires, or the like through which information travels.

The system bus 107 can have a variety of physical configurations. In some embodiments, the system bus can be configured as a backbone connecting the processor 103, the memory 105, and/or the various devices and/or interfaces as shown in the figure. In other embodiments, the system bus 107 can be configured as separate buses that communicatively link one or more components together. For example, the system bus 107 can include a bus communicatively linking the processor 103, the memory 105, and/or circuit board (the bus can alternatively be referred to as the front-side bus, memory bus, local bus, or host bus). The system bus 107 can include multiple additional I/O buses communicatively linking the various other devices and/or interfaces to the processor 103.

It should be appreciated that information shared between the components of the electronic computing device 101 can include program instructions, data, signals such as control signals, commands, bits, symbols, or the like. The information can be represented using a variety of different technologies and techniques. For example, in some embodiments, the information can be represented by voltages, currents, electromagnetic waves, magnetic fields or particles, optical fields, or the like.

The system bus 107 can also be used for other purposes besides sharing information. For example, the system bus 107 can be used to supply power from the power source 129 to the various devices and/or interfaces connected to the system bus 107. Likewise, the system bus 107 can include address lines which match those of the processor 103. This allows information to be sent to or from specific memory locations in the memory 105. The system bus 107 can also provide a system clock signal to synchronize the various devices and/or interfaces with the rest of the system.

The system bus 107 can use a variety of architectures, communication protocols, or protocol suites to communicatively link the processor 103, the memory 105, and/or any of the other devices and/or interfaces. For example, suitable architectures include Industry Standard Architecture (ISA), Extended Industry Standard Architecture (EISA), Micro Channel Architecture (MCA), Video Electronics Standards Association (VESA), Peripheral Component Interconnect (PCI), PCI Express (PCI-X), Personal Computer Memory Card Industry Association (PCMCIA or PC bus), Accelerated Graphics Port (AGP), Small Computer Systems Interface (SCSI), and the like. Suitable communication protocols include TCP/IP, IPX/SPX, Modbus, DNP, BACnet, ControlNet, Ethernet/IP, or the like.

### Program Instructions

The instructions stored in the electronic computing device 101 can include software algorithms and/or application programs. It should be appreciated that the software algorithms can be expressed in the form of methods or processes performed in part or entirely by the electronic computing device 101 or as instructions stored in a computer-readable medium such as the memory 105 and/or the storage device 109. Likewise, the software algorithms are shown in the flowcharts and described in the methods and/or processes.

It should be appreciated that instructions can take the form of entirely software (including firmware, resident software, micro-code, or the like), entirely hardware, or a combination of software and hardware. If implemented in software executed by the processor 103, the information may be stored on or transmitted over a computer-readable medium such as the memory 105 and/or the storage device 109. In some embodiments, the instructions can be contained in any tangible medium of expression having program code embodied in the medium. In some embodiments, the instructions can be written in any combination of one or more programming languages.

It should also be appreciated that the flowcharts, block diagrams, methods, and/or processes describe algorithms and/or symbolic representations of information operations. The algorithmic descriptions and representations are the means used by those skilled in the data processing arts to convey the substance of their work most effectively to others skilled in the art. These operations, while described functionally or logically, are understood to be implemented by software and/or hardware that can be readily and easily created from the functional or logical descriptions of the algorithms.

In some embodiments, the instructions can include firmware such as a basic input/output system (BIOS) 131, an operating system 133, one or more application programs 135, program data 137, and the like. These can be stored in the memory 105 and/or the storage device 109. In general, the instructions are stored in the memory 105 when the electronic computing device 101 is on and running or while the instructions are being used (e.g., an application program is running). Likewise, the instructions are stored in the storage device 109 when the electronic computing device 101 is off.

### Storage Device

Each of the one or more storage devices 109 (alternatively referred to as secondary memory, or a computer-readable medium) is a device or system used to store information that is not needed for immediate use by the processor 103. The storage device 109 can be communicatively linked to the system bus 107 by way of a storage interface 111. The storage device 109 is generally not directly accessible to the processor 103. The storage device 109 is generally less expensive and operates at lower speeds compared to the memory 105. The storage device 109 is also generally non-volatile and used to permanently store the information.

The storage device 109 can take a variety of physical forms and use a variety of storage technologies. For example, in some embodiments, the storage device 109 can be in the form of a hard disk storage device, solid-state storage device, optical storage device, or the like. Also, in some embodiments, the storage device 109 can use technologies such as a magnetic disk (e.g., disk drives), laser beam (e.g., optical drives), semiconductor (e.g., solid-state drives), and/or magnetic tape to store information.

### Display Device

Each of the one or more display devices 113 (alternatively referred to as a human-machine interfaces (HMI) or screens) is a device that visually conveys text, graphics, video, and/or other information. In some embodiments, the information shown on the display device 113 exists electronically and is displayed for a temporary period of time. It should be appreciated that the display device 113 can operate as an output device and/or input device (e.g., touchscreen display or the like).

The display device 113 can be communicatively linked to the system bus 107 by way of one or more graphics interfaces 115. In some embodiments, the graphics interface 115 can be used to generate a feed of output images to the display device 113. In some embodiments, the graphics interface 115 can be a separate component such as a dedicated graphics card or chip or can be an integrated component that is part of or a subset of the processor 103.

It should be appreciated that the display device 113 can include a variety of physical structures and/or display technologies. For example, in some embodiments, the display device 113 can be a screen integrated into a specific application or technology, a separate screen such as a monitor, or the like. The display device 113 can also be a liquid crystal display, a light emitting diode display, a plasma display, a quantum dot display, or the like.

### Input Devices

Each of the one or more input devices 117 is a physical component that provides information to the processor 103 and/or the memory 105. The input device 117 can be communicatively linked to the system bus 107 by way of one or more input interfaces 119. The input device 117 can be any suitable type and can provide any of a variety of information. For example, the input device 117 can be a digital and/or analog device and can provide information in a digital or analog format. Also, the input device 117 can be used to provide user input for controlling the electronic computing device 101 or operational input for controlling aspects of a specific application.

The input device 117 can include one or more sensors 139 and/or one or more other miscellaneous input devices 141. It should be appreciated that the input device 117 is not limited to only providing information. In some embodiments, the input device 117 can also receive information. Such devices can be considered both an input device 117 and an output device 121.

The miscellaneous input device 141 can include a variety of devices or components. In some embodiments, the miscellaneous input devices 141 can include switches such as limit switches, level switches, vacuum switches, pressure switches, or the like, as well as buttons including pushbuttons or the like. In some embodiments, the miscellaneous input devices 141 include user interface components such as a pointing device, for example a mouse, text input devices, for example a keyboard, a touch screen, or the like.

### Sensors

Each of the one or more sensors 139 can be used to provide information about a wide variety of measured properties. In general terms, the sensor 139 is used to measure or detect information about its environment and send the information to the processor 103 and/or the memory 105. In some embodiments, the sensor 139 can operate as a transducer and generate an electrical signal as a function of the measured property. The electrical signal is communicated to the processor 103 and/or the memory 105 where it can be used for a variety of purposes.

The sensor 139 can be a digital sensor and/or an analog sensor. For example, in some embodiments, the sensor 139 provides digital information to the processor 103 and/or the memory 105. In other embodiments, the sensor 139 provides analog information to the processor 103 and/or the memory 105. Also, in some embodiments, the information can be converted from one type to the other—e.g., from digital to analog or from analog to digital.

It should be appreciated that the information provided by the sensor 139 can be used in a variety of ways by the processor 103. For example, in some embodiments, the processor 103 can compare the information to a set point. In some embodiments, analog information is amplified before being compared to the set point.

In some embodiments, the sensor 139 can be used to measure one or more properties. For example, the sensors 139 can be used to measure position, radiation, temperature, sound, and the like.

### Image Sensors

In some embodiments, the sensor 139 is an image sensor used to create an image of an aspect of the system and/or vitrification process. In general, an image sensor is a device that detects and conveys information used to make an image. The image sensor converts the variable attenuation of radiation waves (infrared, visible, and/or ultraviolet spectrum radiation as well as other frequencies) into signals that convey the information.

The image sensor can be any of a variety of types of image sensors. For example, suitable image sensors include electronic image sensors such as a charge-coupled device (CCD), active-pixel sensor (CMOS sensor), or the like. The image sensor can be part of a camera or other imaging device.

### Temperature Sensors

In some embodiments, the sensor 139 is a temperature sensor used to measure the temperature of vitrification process. Temperature is the physical quantity expressing the thermal energy present in matter. In some embodiments, the temperature sensor acts as a transducer and generates an electrical signal as a function of the measured temperature.

The temperature sensor can be a contact type temperature sensor or a non-contact type temperature sensor. Contact type temperature sensors are positioned in physical contact with the material and rely primarily on conduction to detect changes in its temperature. Non-contact type temperature sensors are not positioned in physical contact with the material and rely primarily on convection and/or radiation to detect changes in its temperature.

The temperature sensor can be any of a variety of types of temperature sensors. For example, suitable temperature sensors include thermocouples (type K, J, T, E, N, S, R, or the like), resistance temperature detectors (RTDs), thermistors, bimetallic strips, semiconductor temperature sensors, thermometers, vibrating wire temperature sensors, infrared temperature sensors, or the like.

### Pressure Sensors

In some embodiments, the sensor 139 is a pressure sensor used to measure the In some embodiments, the sensor 139 is a pressure sensor used to measure the pressure of fluids such as pneumatic and/or hydraulic fluids. Pressure is an expression of the force required to stop the fluid from expanding and is expressed in force per unit area. In some embodiments, the pressure sensor acts as a transducer and generates an electrical signal as a function of the measured pressure.

The pressure sensor can be configured to measure a variety of pressures. In some embodiments, the pressure sensor is an absolute pressure sensor configured to measure the pressure relative to a vacuum. In some embodiments, the pressure sensor is a gauge pressure sensor configured to measure the pressure relative to ambient atmospheric pressure. In some embodiments, the pressure sensor is a differential pressure sensor configured to measure the difference between two pressures. In some embodiments, the pressure sensor is a sealed pressure sensor configure to measure the pressure relative to some fixed pressure other than ambient atmospheric pressure.

The pressure sensor can use a variety of pressure sensing technologies. In some embodiments, the pressure sensor can use force collecting pressure sensing technology. These types of electronic pressure sensors use a force collector such as a diaphragm, piston, bourdon tube, bellows, or the like, to measure strain or deflection due to applied force over an area. Examples of suitable force collector pressure sensors includes piezoresistive strain gauge pressure sensors, capacitive pressure sensors, electromagnetic pressure sensors, piezoelectric pressure sensors, strain-gauge pressure sensors, optical pressure sensors, potentiometric pressure sensors, force balancing pressure sensors, or the like. In some embodiments, the pressure sensor can use other properties such as density to infer pressure of a fluid.

### Position Sensors

In some embodiments, the sensor 139 is a position sensor configured to measure the position of the electrodes, grippers, and the like. The position sensor can be used to determine the absolute position or location of the component or the relative position or displacement of the component in terms of linear travel, rotational angle, or three-dimensional space. In some embodiments, the position sensor acts as a transducer and generates an electrical signal as a function of the measured position.

The position sensor can be a contact type position sensor or a non-contact type position sensor. Contact type position sensors are positioned in physical contact with the component to detect changes in its position. Non-contact type position sensors can detect changes in the position of the component without being in physical contact with it.

The position sensor can be any of a variety of types of position sensors and can be used to measure a variety of positions or movements including linear, rotary, and/or angular positions or movements. For example, suitable position sensors include potentiometric position sensors, inductive position sensors such as a linear variable differential transformer or a rotary variable differential transformer, eddy current-based position sensors, capacitive position sensors, magnetostrictive position sensors, hall effect-based magnetic position sensors, fiber optic position sensors, optical position sensors, ultrasonic position sensors, or the like.

### Light Sensors

In some embodiments, the sensor 139 is a light sensor configured to measure various aspects of the system and/or vitrification process. The light sensor can be used to determine the presence and/or intensity of light by measuring the radiant energy that exists in a certain range of frequencies, which typically include the infrared, visible, and/or ultraviolet light spectrum. In some embodiments, the light sensor acts as a transducer and generates an electrical signal as a function of the measured radiant energy.

The light sensor can include a variety of different light sensing technologies. In some embodiments, the light sensor generates electricity when illuminated. Examples of such light sensors include photovoltaic light sensors and photo-emissive light sensors. In some embodiments, the light sensor changes its electrical properties when illuminated. Examples of such light sensors include photoresistor light sensors and photoconductor light sensors.

### Output Devices

Each of the one or more output devices 121 is a physical component that receives information from the processor 103 and/or the memory 105. The output device 121 can be communicatively linked to the system bus 107 by way of one or more output interfaces 123. The output device 121 can be any suitable type and can receive any of a variety of information. For example, the output device 121 can be a digital and/or analog device and can receive information in a digital and/or analog format. Also, the output device 121 can be used to provide information to the user or perform various operations related to the specific application.

The output device 121 can include one or more actuators 143 and/or one or more other miscellaneous output devices 145. It should be appreciated that the output device 121 is not limited to only receiving information. In some embodiments, the output device 121 can also send information. Such devices can be considered both an output device 121 and an input device 117.

The miscellaneous output devices 145 can include a variety of devices or components. In some embodiments, the miscellaneous output devices 145 can include audio output devices such as speakers as well as other output devices.

### Actuators

Each of the one or more actuators 143 can be used to activate movement or an operation. In general terms, the actuator 143 is used to activate something in response to an instruction or control signal sent from the processor 103. In some embodiments, the actuator 143 can act as a transducer by receiving an electrical signal and transforming it into the desired movement or operation.

The information received by the actuator 143 can take a variety of forms and use a number of technologies. For example, the information may be in the form of an electric voltage or current, pneumatic or hydraulic fluid pressure, binary data, or the like. The information can be provided as digital and/or analog format. For example, in some embodiments, the actuator 143 receives digital information from the processor 103 or other component(s) in the electronic computing device 101. In other embodiments, the actuator 143 receives analog information from the processor 103 or other component(s) in the electronic computing device 101. Also, in some embodiments, the information received by the actuator 143 can be converted from one type to the other—e.g., from digital to analog or from analog to digital.

The actuator 143 can use a variety of energy sources to operate. For example, the actuator 143 can operate using electrical energy, hydraulic energy, pneumatic energy, thermal energy, magnetic energy, or the like. Likewise, the actuator 143 can be an electric actuator, hydraulic actuator, pneumatic actuator, thermal actuator, magnetic actuator, or the like. The actuator 143 can also be used to produce a variety of movements. For example, the actuator 143 can be used to produce linear movement and/or rotary movement.

### Motors

In some embodiments, the actuator 143 can include an electric motor. In general, the electric motor is a device that converts electrical energy to mechanical energy. In some embodiments, the mechanical energy produced by the electric motor is in the form of the rotation of a shaft. The mechanical energy can be used directly or converted into other mechanical movement using levers, gears, ratchets, cams, or the like. The motor can be a DC motor or an AC motor.

### Relays

In some embodiments, the actuator 143 can include a relay. In general, a relay is an electrically operated switch. In some embodiments, the relay includes one or more input terminals to receive information or control signals and one or more operating contact terminals electrically linked to a separate electrical device.

In some embodiments, the relays can include electromechanical relays having contacts that mechanically open and close. For example, the relay can include an electromagnet that opens and closes the contacts. In other embodiments, the relays can include solid state relays that use semiconductor properties to control the on or off state of the relay without any moving parts. Solid state relays can include thyristors and transistors to switch currents up to a hundred amps or more.

### Communication Devices

Each of the communication devices 125 is a physical component that allows the electronic computing device 101 to communicate with other devices, components, and/or networks. The communication device can be communicatively linked to the system bus 107 by way of one or more communication interfaces 127. The communication device 125 can include one or more wired communication devices 147 and/or one or more wireless communication devices 149.

It should be appreciated that the communication device 125 can be any suitable physical device. For example, in some embodiments, the communication device 125 is a network interface controller used to connect the electronic computing device 101 to a larger network such as a local area network (LAN), wide area network (WAN), or the Internet.

It should also be appreciated that the communication device 125 can use a variety of communication protocols. For example, in some embodiments, the wired communication device 147 can use communication protocols such as Ethernet, RS-232, RS-485, USB, or the like. Also, in some embodiments, the wireless communication devices 149 can use communication protocols such as Wi-Fi, Bluetooth, Zigbee, LTE, 5G, or the like.

### Power Source

The power source 129 can be used to supply electric power to the electronic computing device 101. The power source 129 can provide any suitable type of power including AC power, DC power, or the like. The power source 129 can obtain power from any suitable source including an AC power source (standard wall outlet), DC power source (a transformer plugged into a wall outlet), battery, generator, or the like.

In some embodiments, the power source 129 includes a power supply that converts electric current from a source to a desired voltage, current, and/or frequency to power the electronic computing device 101. In some embodiments, the power supply can convert AC power ranging from 110-240 VAC to DC power ranging from 6-60 VDC.

### Circuit Board

The electronic computing device 101 can include one or more circuit boards (alternatively referred to as logic boards) to which one or more of the components can be coupled. For example, the processor 103, the memory 105, the storage device 109, the display device 113, the input device 117, the output device 121, the communication device 125, and/or the power source 129 can be coupled to one or more circuit boards. In some embodiments, the processor 103, the memory 105, and/or the storage device 109 can be coupled to one circuit board.

In some embodiments, the circuit board can contain a series of conductive tracks, pads, and/or other features etched from one or more sheet layers of copper laminate laminated onto and/or between sheet layers of nonconductive substrate. The conductive features can be part of the system bus 107 communicatively linking the various components of the electronic computing device 101. In some embodiments, the circuit board can be a printed circuit board. In some embodiments, the circuit board can be a motherboard.

### Illustrative Embodiments

P1. A camera protection system, comprising: a camera, wherein the camera comprises at least a camera lens and a camera body, and wherein the camera lens and the camera body are oriented at an angle to a viewport and a source of radiation; a first surface mirror or second surface mirror operably placed in front of the camera lens, and wherein a surface of the first surface mirror or second surface mirror is coated with a reflective material; shielding, wherein the shielding protects the camera from gamma radiation.
P2. The system of P1, wherein the reflective material is a gold coating.
P3. Systems and methods for reflecting gamma radiation from a camera using a right-angle first surface mirror or a second surface mirror.
P4. The systems and methods of P3, wherein the right-angle first surface mirror or the second surface mirror has a film coating on one or more surfaces.
P5. The systems and methods of P4, wherein the film coating is comprised of gold.
P6. The systems and methods of P3, wherein the camera is an infrared camera.
P7. Systems and methods for reflecting harmful rays from a camera using a right-angle first surface mirror or a second surface mirror.
P8. The systems and methods of P7, wherein the right-angle first surface mirror or the second surface mirror has a film coating on one or more surfaces.
P9. The systems and methods of P8, wherein the film coating is comprised of gold.
P10. The systems and methods of P7, wherein the camera is an infrared camera.

### General Terminology and Interpretative Conventions

Any methods described in the claims or specification should not be interpreted to require the steps to be performed in a specific order unless expressly stated otherwise. Also, the methods should be interpreted to provide support to perform the recited steps in any order unless expressly stated otherwise.

Certain features described in the context of separate implementations can also be implemented in combination in a single implementation. Conversely, various features that are described in the context of a single implementation can also be implemented in multiple implementations separately or in any suitable subcombination. Moreover, although features may be described above in certain combinations and even initially claimed as such, one or more features from a claimed combination can be excised from the combination, and the claimed combination may be directed to a subcombination or variation of a subcombination.

The example configurations described in this document do not represent all the examples that may be implemented or that are within the scope of the claims. The term “example” shall be interpreted to mean “serving as an example, instance, or illustration,” and not “preferred” or “advantageous over other examples.”

Articles such as “the,” “a,” and “an” can connote the singular or plural. Also, the word “or” when used without a preceding “either” (or other similar language indicating that “or” is unequivocally meant to be exclusive—e.g., only one of x or y, etc.) shall be interpreted to be inclusive (e.g., “x or y” means one or both x or y).

The term “and/or” shall also be interpreted to be inclusive (e.g., “x and/or y” means one or both x or y). In situations where “and/or” or “or” are used as a conjunction for a group of three or more items, the group should be interpreted to include one item alone, all the items together, or any combination or number of the items.

The phrase “based on” shall be interpreted to refer to an open set of conditions unless unequivocally stated otherwise (e.g., based on only a given condition). For example, a step described as being based on a given condition may be based on the recited condition and one or more unrecited conditions.

The terms have, having, include, and including should be interpreted to be synonymous with the terms comprise and comprising. The use of these terms should also be understood as disclosing and providing support for narrower alternative implementations where these terms are replaced by “consisting” or “consisting essentially of.”

Unless otherwise indicated, all numbers or expressions, such as those expressing dimensions, physical characteristics, and the like, used in the specification (other than the claims) are understood to be modified in all instances by the term “approximately.” At the very least, and not as an attempt to limit the application of the doctrine of equivalents to the claims, each numerical parameter recited in the specification or claims which is modified by the term “approximately” should be construed in light of the number of recited significant digits and by applying ordinary rounding techniques.

All disclosed ranges are to be understood to encompass and provide support for claims that recite any subranges or any and all individual values subsumed by each range. For example, a stated range of 1 to 10 should be considered to include and provide support for claims that recite any and all subranges or individual values that are between and/or inclusive of the minimum value of 1 and the maximum value of 10; that is, all subranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth), which values can be expressed alone or as a minimum value (e.g., at least 5.8) or a maximum value (e.g., no more than 9.9994).

All disclosed numerical values are to be understood as being variable from 0-100% in either direction and thus provide support for claims that recite such values (either alone or as a minimum or a maximum—e.g., at least <value> or no more than <value>) or any ranges or subranges that can be formed by such values. For example, a stated numerical value of 8 should be understood to vary from 0 to 16 (100% in either direction) and provide support for claims that recite the range itself (e.g., 0 to 16), any subrange within the range (e.g., 2 to 12.5) or any individual value within that range expressed individually (e.g., 15.2), as a minimum value (e.g., at least 4.3), or as a maximum value (e.g., no more than 12.4).

The terms recited in the claims should be given their ordinary and customary meaning as determined by reference to relevant entries in widely used general dictionaries and/or relevant technical dictionaries, commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used in a manner that is more expansive than its ordinary and customary meaning, the term should be given its ordinary and customary meaning plus the additional expansive meaning, or (b) if a term has been explicitly defined to have a different meaning by reciting the term followed by the phrase “as used in this document shall mean” or similar language (e.g., “this term means,” “this term is defined as,” “for the purposes of this disclosure this term shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained in this document should be considered a disclaimer or disavowal of claim scope.

The subject matter recited in the claims is not coextensive with and should not be interpreted to be coextensive with any implementation, feature, or combination of features described or illustrated in this document. This is true even if only a single implementation of the feature or combination of features is illustrated and described.

### Incorporation By Reference

The entire content of each document listed below is incorporated by reference into this document (the documents below are collectively referred to as the “incorporated documents”). If the same term is used in both this document and one or more of the incorporated documents, then it should be interpreted to have the broadest meaning imparted by any one or combination of these sources unless the term has been explicitly defined to have a different meaning in this document. If there is an inconsistency between any incorporated document and this document, then this document shall govern. The incorporated subject matter should not be used to limit or narrow the scope of the explicitly recited or depicted subject matter.

Benefit/priority patent documents incorporated by reference:
Int'l Pat. Pub. No. WO 2024/121648 (App. No. PCT/IB2023/061298), titled “Systems and Methods for Camera Protection in Hazardous Environments,” filed on 9 Nov. 2023, published on 13 Jun. 2024.
U.S. Prov. App. No. 63/386,780, titled “Systems and Methods for Camera Protection in Hazardous Environment,” filed on 9 Dec. 2022.

What is claimed is:

1. A camera protection system, comprising:
a camera including a camera lens and a camera body, the camera lens and the camera body being oriented at an angle to a viewport and a source of radiation;
a first surface mirror or second surface mirror operably placed in front of the camera lens; and
shielding positioned to protect the camera from gamma radiation emitted by the source of radiation;
wherein a surface of the first surface mirror or a surface of the second surface mirror is coated with a reflective material.

2. The camera protection system of claim 1 wherein the reflective material is a gold film.

3. The camera protection system of claim 1 wherein the reflective material comprises at least one of aluminum or silver.

4. The camera protection system of claim 1 wherein the first surface mirror or the second surface mirror is positioned at an angle of approximately 45 degrees relative to an optical axis of the viewport.

5. The camera protection system of claim 1 wherein the shielding comprises lead having a thickness of approximately 60 mm to approximately 65 mm.

6. The camera protection system of claim 1 wherein the source of radiation is a radioactive waste vitrification process.

7. A camera protection system comprising:
a container having an interior space;
a camera positioned outside the container;
a mirror positioned adjacent to a viewport of the container, the mirror having a reflective layer configured to reflect infrared signals from the interior space of the container toward the camera while allowing gamma radiation to pass through the mirror without substantial reflection; and
a shielding structure positioned around the camera, wherein the shielding structure comprises a radiation-absorbing material structured to reduce gamma radiation exposure to the camera.

8. The camera protection system of claim 7 wherein the reflective layer comprises gold.

9. The camera protection system of claim 7 wherein the reflective layer comprises at least one of aluminum or silver.

10. The camera protection system of claim 7 wherein the mirror is positioned at an angle of approximately 45 degrees relative to an optical axis extending from the interior space through the viewport.

11. The camera protection system of claim 7 wherein the radiation-absorbing material comprises lead.

12. The camera protection system of claim 11 wherein the lead has a thickness of at least 60 mm.

13. The camera protection system of claim 7 wherein the camera is an infrared camera.

14. The camera protection system of claim 7 wherein the mirror is a first surface mirror.

15. A radiation imaging apparatus comprising:
a housing defining an interior region configured to hold a radiation source;
a viewport coupled to the housing;
a camera positioned at an angle relative to the viewport such that the camera is outside a direct path of gamma radiation emitted through the viewport; and
a first surface mirror or second surface mirror positioned in an optical path between the viewport and the camera, wherein a surface of the first surface mirror or a surface of the second surface mirror is coated with a gold film configured to reflect infrared radiation while being substantially transparent to the gamma radiation;
wherein the camera is positioned to capture infrared images of contents within the interior region via the first surface mirror and/or the second surface mirror while being protected from direct exposure to the gamma radiation.

16. The radiation imaging apparatus of claim 15 comprising a protective housing positioned around the camera, wherein the protective housing comprises lead shielding structured to attenuate the gamma radiation.

17. The radiation imaging apparatus of claim 16 wherein the lead shielding has a thickness of approximately 60 mm to approximately 65 mm.

18. The radiation imaging apparatus of claim 15 wherein the angle between an optical axis of the camera and an optical axis of the viewport is approximately 90 degrees.

19. The radiation imaging apparatus of claim 15 wherein the radiation source comprises radioactive waste undergoing vitrification.

20. The radiation imaging apparatus of claim 15 wherein the camera is communicatively linked to a processor and memory, wherein the memory includes instructions that when executed by the processor analyze the infrared images to monitor a temperature of the contents within the interior region.
